(19) United States
(12) Patent Application Publication
(10) Pub. No.: US 2022/0327556 A1
(43) Pub. Date: Oct. 13, 2022

(54) Relevance-Driven Feed for Financial Market Data

(71) Applicant: Logan Smyth, Columbus, OH (US)

(72) Inventor: Logan Smyth, Columbus, OH (US)

(21) Appl. No.: 17/711,414

(22) Filed: Apr. 1, 2022

Related U.S. Application Data
(60) Provisional application No. 63/170,036, filed on Apr. 2, 2021.

(51) Int. Cl. G06Q 30/02

(52) U.S. Cl. CPC G06Q 30/0201

(57) ABSTRACT

Methods, devices, and systems for generating a feed for market data in real-time based on comparative relevance of the financial data. A relevance-driven feed is generated by importing multiple inputs of financial data for a selected asset, sector, index, or class. A plurality of relevance scores are calculated for selected assets, sectors, indexes, or classes for a given time interval based on historical data for the selected assets, sectors, indexes, or classes. An ordered relevance list is then generated from the plurality of relevance scores. The relevance list is then communicated to a user. The relevance list may be based on single factor or multiple factor metrics.

### CROSS-REFERENCE TO RELATED APPLICATION

The present application claims priority to, and the benefit of, U.S. Provisional Application No. 63/170,036, which was filed on Apr. 2, 2021 and is incorporated herein by reference in its entirety.

### BACKGROUND

The present invention generally relates to financial market data feeds, and more specifically to a method for populating a relevance-driven feed for financial market data. Accordingly, the present specification makes specific reference thereto. However, it is to be appreciated that aspects of the present invention are also equally amenable to other like applications, devices and methods of manufacture.

Current options for keeping up with relevant financial market data, in near real time and in a way that is easily accessible, are quite limited. The vast majority of mobile applications currently available for following financial markets all use the same or very similar approaches. In most cases the applications will provide the user with a pre-populated list of indices or securities. These are typically major equity indices or large cap companies that most people are familiar with. In these situations, the data is generic in nature and is presented in a static, predetermined order. Most often, this data is narrowly focused on US equities. This may be suitable for a basic level of information but does not provide any context to the data being presented. Further, for existing applications that do sort the data, by say percentage change, extreme values would be at the top and bottom of the list (the biggest percentage gains at the top of the list and the biggest percentage losses at the bottom or vice versa). Sorting by relevance combines both positive and negative moves so that the most relevant moves are surfaced, regardless of whether the move is positive or negative.

In some situations, existing applications may employ screeners that surface companies deemed “most active” or “biggest gainers” by trading volume, price increase, or some similar metric. Even in these situations, though, it is sometimes unclear why, or especially to what degree, the data being presented qualifies for the list. These filters used by existing methods surface this data only in nominal terms.

Therefore, there exists a long felt need in the art for a method that surfaces what information is most relevant at any given time. Something that is not found elsewhere in any existing applications. There is also a long felt need for a method that presents the data in the context of the available historical data. Additionally, there is a long felt need in the art for a method that would enable an application to provide context and relevance to the user by simplifying the movements of the various metrics into relevance scores and highlighting the most relevant movements at any given time. Finally, there is a long felt need in the art for a method that could be applied to multiple sub-feeds focusing on different aspects of financial markets including, but not limited to, performance, breadth, technical analysis, bullish movements, bearish movements, fundamentals, etc.

In this manner, the improved relevance-driven feed of the present invention accomplishes all of the forgoing objectives, thereby providing an easy solution for providing relevance and context to vast sums of financial data. A primary feature of the present invention is the ability of an application to quickly distill vast amounts of financial markets data in near real time and surface the most relevant information to the user. Finally, the improved relevance-driven feed of the present invention is capable of populating a feed, or multiple feeds, on a mobile application.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a computer network system and method for populating a relevance-driven feed for financial market data. The computer network system is accessible by a plurality of users via a network. A server hosts a relevance-feed platform that is operable via a processor. The relevance-feed platform comprises a plurality of logics used to perform the method. The plurality of logics include a data layer, a compute layer, and an algo layer. A plurality of external market data sources are accessible via the platform.

The data layer imports multiple sources of financial markets data and other relevant data for controlling the process. The three main inputs to the method comprise monitored securities, monitored series, and monitored metrics. Additional inputs comprise, but are not limited to, component weightings within indices, sector weightings, and proprietary groupings. These inputs serve as the control tables that control the method. Historical data and current values are also inputs to the process, although they are merely inputs for calculations and do not control the process.

The compute layer calculates relevance scores (referred to as the TRADR Relevance Score or TRS) for each combination of inputs. Combinations are comprised of either a monitored security or a monitored series, an applicable monitored metric, and a time period for the historical data. For each combination, the objective is the same, to compare the current value relative to the available historical data. This is accomplished using an appropriate statical method, primarily a percentile rank. However, depending on the combination the standard deviation from the mean or another statistical method may be appropriate. In all cases, the TRS is an integer from 0 to 100. This corresponds to the degree of statistical extremity of the current value relative to the historical data. It is intended to communicate relevance in a clear, simple, and consistent manner across all combinations. It is further intended to adjust for the different distributions of data observed across all combinations of monitored securities/series/metrics/time periods.

The exact method of calculating a relevance score is based on the monitored metric. Since not all metrics measure data the same way, the approach may be slightly different in certain cases. In some cases, very high and very low values would both be deemed relevant. In other cases, only high values may be of relevance. In addition to relevance scores calculated for individual securities, relevance scores can also be calculated for groups of securities. Equity indices and sectors would be weighted based on their respective component weightings. Proprietary groups or other groupings of securities would, in most cases, be weighted by market capitalization unless a different weighting methodology was more appropriate to the situation. In some cases, group relevance scores may be calculated after aggregating data. This may include relevance scores calculated for equity indices, sectors, or proprietarily defined groups. In other cases, relevance scores may be calculated before aggregating data. An example might be when looking at the breadth of relevance, which is the number of individual securities within a given group that are registering high relevance scores.

The algo layer is the final step in the method. After all the relevance scores have been calculated, the scores can be used to generate an ordered list. The natural implantation is a list in descending order of relevance, surfacing the most relevant data to the top. The ordered list, though, can be created using a single factor or multiple factors. A single-factor list would be driven by a single metric such as one day percentage change in price. A multi-factor list may incorporate additional metrics such as one day volume or trailing 30 day realized volatility as well. A multi-factor list would use a pre-determined weighted average for each variable or a dynamic method for assigning weights to each variable.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exemplary computer network system environment of one embodiment of the present invention for populating a relevance-driven feed for financial market data in accordance with the disclosed architecture.

FIG. 2 illustrates a block diagram of the computer network system for populating a relevance-driven feed for financial market data in accordance with the disclosed architecture.

FIG. 3 illustrates a block diagram of a relevance-feed generating platform of the computer network system for populating a relevance-driven feed for financial market data in accordance with the disclosed architecture.

FIG. 4 illustrates a graph illustrating a plurality of relevance scores based on the data of Table 1 using the relevance-feed generating platform of the computer network system for populating a relevance-driven feed for financial market data in accordance with the disclosed architecture.

FIG. 5 illustrates a histogram illustrating the differences in stock performance based on the data of Table 1 using the relevance-feed generating platform of the computer network system for populating a relevance-driven feed for financial market data in accordance with the disclosed architecture.

FIG. 6 illustrates a graph illustrating a plurality of relevance scores based on the data of Table 3 using the relevance-feed generating platform of the computer network system for populating a relevance-driven feed for financial market data in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a method for populating a relevance-driven feed for financial market data. One function of the method is to provide relevance for the data. The method quickly distills vast amounts of financial markets data in near real time and surfaces the most relevant information. Financial markets are comprised of multiple different asset classes, thousands of securities, each with multiple applicable metrics. It is simply too difficult to monitor so many different data points simultaneously, especially from a mobile device. This method solves that problem by programmatically monitoring every combination and surfacing what is most relevant to the user.

An additional function of the method is to provide context to the information. As has been established in the different examples, a 1% move is not the same for each security. This method addresses that disparity by providing a consistent relevance score that can be applied across all securities, series, and metrics. This standardized approach provides instant context to the data.

The method is configured to enable an application to provide context and relevance to the user by simplifying the movements of the various metrics into relevance scores and highlighting the most relevant movements at any given time. The method may be applied to multiple sub-feeds focusing on different aspects of financial markets including, but not limited to, macroeconomics, performance, breadth, technical analysis, bullish data, bearish data, fundamentals, international, etc.

Additionally, the method is configured to generate user-defined custom relevance-driven feeds. Almost all brokerage and financial market applications allow users the ability to create a watch list of specific securities they follow or are invested in. This information is almost always presented in the same static order. Further, these watch lists are predominantly constrained only to individual securities. Some applications provide the ability to sort the data by a specific metric, such as percent change, but that data is again presented in nominal terms. User-defined custom relevance-driven feeds would be broader in scope allowing for users to create feeds including any monitored item, whether it be an individual security, an index, a sector, a proprietarily defined group, an economic data series, or the like. User-defined custom relevance-driven feeds would also offer considerably more flexibility than conventional watch lists. Users would be able to create either single-factor or multi-factor feeds, specifying which monitored securities to include, which monitored metric(s) to include, time period, and the weighting applied to the monitored metrics (in the case of a multi-factor feed). These user-defined custom relevance-driven feeds would in effect be a more dynamic, customizable version of a conventional watch list.

The method is also configured to user-defined custom relevance-driven feeds, similar in nature to the relevance-driven feed. The key differentiator being that the user could set a list of monitored items to follow and the method would generate an ordered list based on relevance at any given time. Additionally, it would provide greater context to the daily movements of the monitored items. These user-defined custom relevance-driven feeds would present the same data users are accustomed to, but in a manner that provides greater value allowing the user to quickly see the most relevant information on any given day for the monitored items and the monitored metrics they wish to follow. Additionally, the method provides historical context to the data presented.

Additionally, users can create user-defined custom relevance-driven feeds using either a single factor, or a multifactor approach. Custom feeds would allow users to specify not just the monitored securities or monitored series, but also the monitored metric, allowing users to focus not just on the one day percentage change shown in traditional watch lists, but on any metric or combination of metrics they choose. For example, a user may want to create a custom feed that focuses only on volume for certain securities. Another example may be a user who wants to create a multi-factor feed and wants to use a 50% weighting for a technical indicator (such as RSI) and a 50% weighting for volume. Yet another example, might be a user who wishes to look at data from the past 5 days instead of only the current day. Existing watch lists typically only use the one-day percentage change in price for the current day. This option allows users to customize the monitored items, the metrics used, the weighting, and the time period.

One application of the method is to populate a feed, or a series of feeds, in a mobile application. This method can be applied to any number of subgroups of data. It is possible to generate multiple different feeds focusing on different areas within broader financial markets. A natural implementation would be a core feed focusing on broad macro factors, major equity indices (domestic and international), domestic equities and sectors, sovereign fixed income from major countries, commodities, foreign exchange, and cryptocurrencies. This would provide the broadest number of inputs to the method and would provide a great deal of utility by monitoring most major financial markets, asset classes, and securities.

The core feed would be supplemented by multiple sub-feeds focusing on specific areas within broader financial markets, comprising performance, economic, technical, fundamental, breadth, bullish, bearish, international, etc. These sub feeds would be populated using the same method, except the feeds would be restricted to data pertinent to the specific subgroup.

An additional application of the method is to create a user-defined custom relevance-driven feed. This would be similar in nature to the watch lists found on almost all brokerage and financial applications. The key differentiator being that the user could set a list of monitored items to follow and the method would generate an ordered list based on relevance at any given time. This custom feed could also be expanded over what has traditionally been available, to allow users to follow anything within the available universe of monitored securities, monitored series, and monitored metrics.

The application could be expanded beyond a mobile application to a website or computer software. Additionally, it could continue to be enhanced by expanding the universe of available data fed into the method. The application may be used to create customized single or multifactor feeds based on any weighting desired or to add additional asset classes, such as options or futures. The application could also be expanded via licensing arrangements with traditional brokerage firms to provide custom feed to their clients.

One advantage of the method is the ability to provide relevance and context to vast sums of financial data. The method's ability to surface the most relevant data at any given time is a vast improvement over the current slate of available options. It also automates a task that would be near impossible to do manually, especially on a mobile device.

In addition to surfacing relevant data, the method also provides context to the vast sums of financial data. When traditional applications display data in terms of percentage changes, that data is only useful to a point. It may provide the user information in nominal terms, but it does not provide any information relative to the security's available historical data. Further, a simple percentage is not consistent across securities or asset classes. This method provides a clear, simple, and consistent metric that instantly provides context across all combinations of monitored securities, monitored series, and monitored metrics. This allows the user to instantly understand the significance of any given data point.

More specifically, the present invention comprises a method for creating and populating a feed for financial market data that surfaces individual securities, sectors, indices, metrics, or other related data points based on their relevance. The method applies to a universe of monitored metrics as they pertain to different universes of monitored securities and monitored series. The method determines relevance by calculating a relevance score, achieved by comparing current readings to available historical data, using a percentile ranking or other applicable statistical method. The more extreme the current reading, relative to available historical data, the more relevance would be inferred upon the underlying monitored security or series. Depending on the underlying security/series, relevance may be determined to be a high percentile rank, low percentile rank, or both. The relevance score for a security or series can be attained using an individual metric of a weighted composition of multiple metrics.

The intended effect of the method is to distill the enormity of data surrounding financial markets, into a feed that highlights the most relevant data at any given time. Significantly, this method allows that data to be evaluated and ranked consistently across multiple unrelated securities and series. Using this method, relevance scores are determined by the degree of the deviation of the current reading from historical data. Using the relevance scores, a feed can be populated that highlights the most relevant readings at any given time, across multiple related or unrelated securities and series. The feed may also include information in the form of charts or graphs in addition to calculated scores.

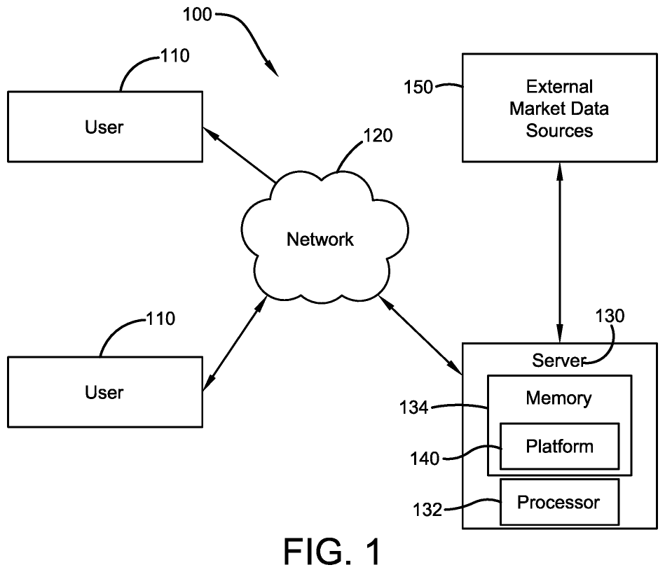

Referring to the drawings, FIGS. 1-3 illustrate a system 100 for generating a relevance-driven feed for financial market data. The system 100 is configured to generate a plurality of relevance-driven feeds for financial market data. As illustrated in FIG. 1, the system 100 is configured for access via a plurality of users 110 over a network 120. The relevance-driven feed includes an ordered relevance list configured to allow a user to evaluate and rank related and unrelated securities and series based on a plurality of inputs of financial market data for each of the related and unrelated securities and series.

The system 100 comprises a server 130 hosting a memory 134 storing a set of software instructions in the form of a relevance-feed platform 140. When executed by the processor 132, the relevance-feed platform 140 performs methods of the present invention. The system 100 is configured to access a plurality of financial market data from a plurality of external market data sources 150 via the network 120. Next, a plurality of inputs are imported to the relevance-feed platform 140 from the plurality of economic data for a plurality of monitored items.

A data layer is then created from the plurality of inputs of financial market data, and a plurality of relevance scores are generated from the plurality of inputs. The relevance-feed platform 140 further creates and continuously updates an ordered relevance list of the plurality of relevance scores for each of the plurality of monitored items. Once generated, the continuously updated ordered relevance lists are transmitted to one or more user interfaces 110.

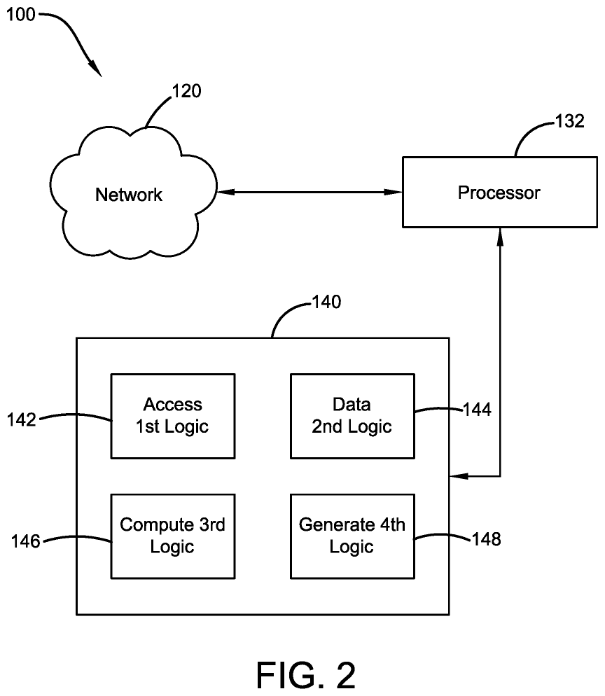

As illustrated in FIG. 2, the relevance-feed platform 140 comprises a first logic 142. The first logic 142 is an access logic stored in the memory 134. When executed by the processor 132, the first logic 142 accesses a plurality of monitored items data from the plurality of external market data sources 150 via the network 120. The relevance-feed platform 140 further comprises a second logic 144. The second logic 144 is a data logic stored in the memory 134. When executed by the processor 132, the second logic 144 is configured to create a data layer from the plurality of inputs of financial market data and generate a plurality of relevance scores from the plurality of inputs.

The relevance-feed platform 140 further comprises a third logic 146. The third logic 146 is a computing logic stored in the memory 134. When executed by the processor 132, the third logic 146 is configured to create and continuously update an ordered relevance list of the plurality of relevance scores for each of the plurality of financial assets. The relevance-feed platform 140 further comprises a fourth logic 148. The fourth logic 148 is a computing logic stored in the memory 134. When executed by the processor 132, the fourth logic 148 is configured to transmit the continuously updated ordered relevance lists to one or more user interfaces 110 via the network 120.

The plurality of relevance scores are each based on a unique combination of the plurality of inputs as described infra. Each ordered relevance list may be based on a time-based performance of the monitored item, a trading volume of the monitored item, or a daily trading range of the monitored item and then compared to a plurality of historical data. The server 130 is further configured to evaluate and rank each of the plurality of monitored items by each of the respective ordered relevance lists.

A method of generating a relevance-driven feed for financial market data uses the computer-based system 100 accessible via a user input 110 connected to the computer-based system 100 over the network 120. The method begins by importing a plurality of inputs of financial market data for a monitored item from the external market data sources 150 as described infra. The monitored item may be a publicly traded security, a financial asset, an economic data series, an equity index, a sector, a proprietarily defined group, or the like.

The plurality of inputs may comprise a plurality of monitored securities, a plurality of monitored series, or a plurality of monitored metrics. The plurality of monitored series are a plurality of data series based on non-traded economic and financial data. The plurality of monitored metrics are a plurality of quantifiable measures used to track and assess a plurality of factors attributable to the monitored securities, the monitored series, or both. The plurality of inputs may further comprise a plurality of component weightings within indices, a plurality of sector weightings, or a plurality of proprietary groupings.

Next, a data layer 144 is created from the plurality of inputs of financial market data. Each unique combination of the inputs, principally current values, are evaluated over a time period compared to a historical data set for the unique combination of the inputs. Then a plurality of relevance scores are generated from the plurality of inputs, each of the plurality of relevance scores based on a unique combination of the plurality of inputs. Each of the plurality of inputs are compared to the plurality of historical data to generate the plurality of relevance scores. Next, an ordered relevance list of the plurality of relevance scores is created. The ordered relevance list may be based on a time-based performance of the financial asset, a trading volume of the financial asset, a daily trading range of the monitored item or the like.

The method continues by updating the ordered relevance list as new relevance scores are generated and generating the relevance-driven feed based on the updated ordered relevance list. the relevance-driven feed may be a macro feed, a performance feed, a breadth feed, a bearish feed, a bullish feed, or the like. Then the relevance-driven feed is sent over the network 120 to the user input 110. The method may continue by further generating a second plurality of relevance scores for a second monitored item and evaluating and ranking a relevance of the monitored item against the second monitored item.

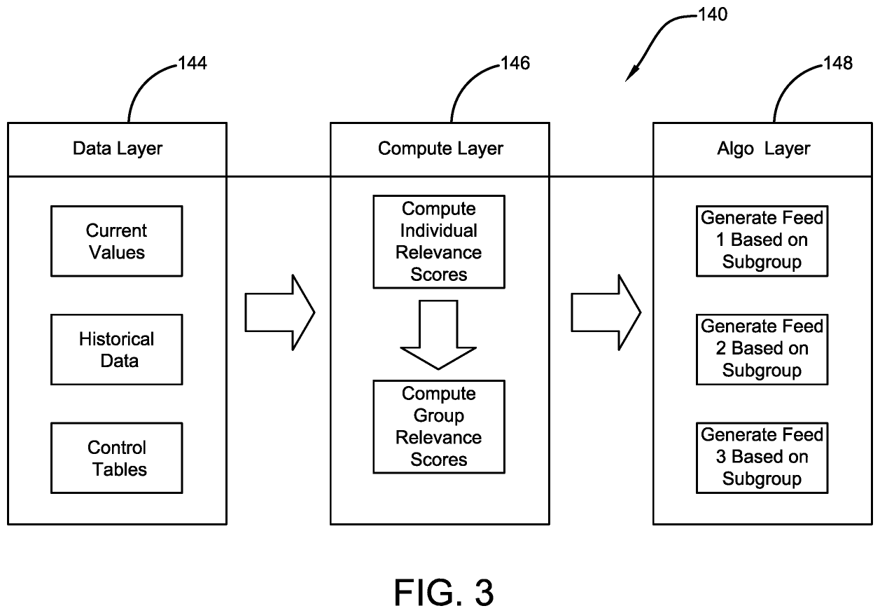

As illustrated in FIG. 3, the method functions based on three layers: the data layer 144, the compute layer 146, and the algo layer 148. The data layer imports multiple sources of financial markets data and other relevant data for controlling the process. The three main inputs to the method comprise monitored securities, monitored series, and monitored metrics. Additional inputs comprise, but are not limited to, component weightings within indices, sector weightings, and proprietary groupings. These inputs populate the control tables that control the method. Historical data and current values are also inputs to the process, although they are merely inputs for calculations and do not control the process.

Monitored securities, monitored series, and monitored metrics are the main inputs to this process for creating a relevance-driven feed. One of the main advantages of this process over conventional means of following markets is the ability to quickly distill vast amounts of information and generate a simple output that puts that information in context. Given that, the more information that is fed into the process, the greater possibility there is to generate context and value to the end user.

Monitored securities can best be defined as publicly traded securities. Examples comprise, but are not limited to individual equities, groups of equities, indices, fixed income, commodities, foreign exchange, cryptocurrencies, and derivative products. Examples include, but are not limited to: Individual equities, such as Apple, Microsoft, Boeing, Johnson & Johnson, Tesla, Abbott Labs, etc.; Groups of Equities, such as proprietarily defined groups of individual equities, such as Streaming Services Related Companies—Roku, Netflix, Google, Apple, Amazon, etc., Chinese Technology Companies—Alibaba, Baidu, Tencent, JD.com, etc., Cannabis Companies—Canopy Growth, Cronos, Aphria, Tilray, etc., Enterprise Software—Salesforce, ServiceNow, Zoom, Shopify, etc.; Indices, such as S&P 500, Nasdaq 100, Russell 2000, Stoxx 600, CAC 40, etc.; Sectors, such as Financials, Telecom, Technology, Industrials, etc.; Fixed Income, such as Domestic Sovereign Bonds—US 2 YR, US 5 YR, US 10 YR, US 30 YR, etc., International Sovereign Bonds—UK 10 YR, France 10 YR, Japan 30 YR, etc., Corporate Bonds, and Municipal Bonds; Commodities, such as Crude oil, Corn, Rice, Cattle, Gold, Silver, Coffee, etc.; Foreign Exchanges, such as EUR/USD, USD/JPY, EUR/GBP, etc.; Cryptocurrencies, such as Bitcoin, Ethereum, etc.; and Derivatives, such as options and future contracts.

Monitored series can best be defined as non-traded, economic/financial data series. Examples comprise, but are not limited to data series covering industry, employment, consumer, and credit. For example: Industry, such as PMI Indices, Durable Goods Orders, Industrial Production, and Vehicle Sales; Employment, such as, Non-farm Payrolls, Initial Jobless Claims, and Continuing Jobless Claims; Consumer, such as Retain Sales, Consumer Confidence, and Consumer Debt; and Credit, such as, High Yield Credit Spreads, Commercial and Industrial Loans, and Mortgage Delinquencies.

Monitored metrics can best be defined as quantifiable measures used to track and assess multiple factors attributable to monitored securities, monitored series, or both. With respect to monitored securities, some monitored metrics are more applicable than others and may best be grouped into primary metrics and secondary metrics.

The primary monitored metrics that apply to monitored securities will pertain to market data for publicly traded securities such as price, volume, and volatility. These metrics are the core data of publicly traded financial markets and any positive/negative impact to a monitored security would be reflected in these metrics first. As such, changes in these metrics are of higher import than other supplemental metrics.

There are secondary monitored metrics that are applicable to monitored securities but are of lesser importance as they provide more supplemental information. Examples of these metrics would be fundamentals, breadth, technical analysis studies, performance, etc. These secondary metrics are slower to change and more often backward looking. As such, they are less suited to driving the behavior of the feed. They are still worthy of monitoring as they can provide additional context but are of less importance than the primary monitored metrics.

There are fewer monitored metrics that are applicable to a monitored series. Since monitored series are typically only updated weekly or monthly, the cadence of updates is much slower. There is also typically only a single value, unlike financial market data that can have multiple supplemental data points. As such, there are fewer monitored metrics that are applicable to monitored series. The primary metrics would be the rate of change (w/w, m/m, y/y, SAAR, etc.) in the underlying series and the absolute value of the series relative to the historical data.

Alternatively, theses secondary monitored metrics are available to users when creating custom single or multi-factor feeds and would allow users to create feeds that lean more heavily on these if they should choose. Unrelated to the user driven aspects, theses secondary monitored metrics may also be used to drive feed behavior. The secondary metrics could be weighted together to form a fourth input to the feed behavior. For example, price/volume/daily range may be assigned a weight of 30% each and any applicable secondary metrics are equally weighted and that fourth input would be given 10% weighting in a multi-factor feed.

Another approach may utilize a point based “flag system”. With such an approach, any metric above a given threshold would be considered relevant, say a TRS greater than 80. If there were 20 monitored metrics that applied to a given monitored security, the process would get a count of how many metrics were flagged as relevant. This would be included in the data displayed to the user, so users would be able to see that 18/20 metrics were flagged as relevant. It would also be possible to convert that count into a TRS. With all the available historical data, the system may calculate that 18/20 metrics would equate to a TRS of 95 depending on how infrequently 18 metrics are flagged as relevant.

Examples of monitored metrics applicable to monitored securities comprise, but are not limited to: Primary Metrics, such as a 1-day percentage change in price, a 1-day percentage change in yield (applicable to fixed income), Volume (absolute relative to historical data), and Volatility (realized or implied); Secondary Metrics, such as Price (A from 20/50/200 day moving average (%) and Daily trading range as a % of previous close), Volume (% change d/d, w/w, m/m and Δ from 20/50/200 day moving average (%)), Fundamental (Valuations relative to historical data—P/E, P/B, P/S, etc. and Rate of change in revenue, earnings, capex, etc.), Performance (Weekly performance relative to prior periods and Monthly performance relative to prior periods), Technical (Relative strength index, trend, and Simple moving average inflections), and Breadth (Number or percentage of advancing to declining securities, New highs/lows, and % of securities overbought/oversold). Examples of monitored metrics applicable to monitored securities comprise, but are not limited to: Rate of change (w/w, m/m, y/y, SAAR, etc.); and Absolute value relative to historical data.

The compute layer calculates relevance scores (referred to as the TRADR Relevance Score or TRS) for each combination of inputs. Combinations are comprised of either a monitored security or a monitored series, an applicable monitored metric, and a time period for the historical data. For each combination, the objective is to compare the current value relative to the available historical data. This is accomplished using an appropriate statical method, primarily a percentile rank. However, depending on the combination the standard deviation from the mean or another statistical method may be appropriate. In all cases, the TRS is an integer from 0 to 100. This corresponds to the degree of statistical extremity of the current value relative to the historical data. It is intended to communicate relevance in a clear, simple, and consistent manner across all combinations. It is further intended to adjust for the different distributions of data observed across all combinations of monitored securities/series/metrics/time periods.

There are a plurality of ways to calculate relevance scores. The appropriate calculation method is endemic to the combination of security/series, metric, and time period. For a metric such as the 1-day percentage change in the price of a security, it is important to flag days with big up moves as well as big down moves. For a metric like volume, meanwhile, it would only be important to flag days with high volume. Days with low volume are of low significance as they correspond with days minor price changes and no major news.

The following cases are used to illustrate aspects of the method.

Case 1-1-Day Percentage Change, Equities, High & Low Values

The 1-day percentage change in the price of a high volatility company like Tesla is vastly different than the 1-day percentage change in the price of a low volatility company like Coca-Cola. By calculating the percentile rank of Tesla and Coca-Cola's 1-day percentage change, relative to the company's historical data, the relevance of a given day's 1-day percentage change may be determined. The method presumes that a higher percentile rank for a given monitored metric implies that it is more relevant.

Based on analysis, it makes the most sense to evaluate positive moves and negative moves separately. This is because equities tend to move higher on average, so combining the two diminishes the importance of the downward moves. Further, even though equities tend to move higher on average, the downward moves are typically sharper. For these reasons, evaluating the two separately helps to highlight the importance of moves in either direction. It should be noted that while the preferred approach is evaluating positive and negative moves separately using percentile rank, both could be evaluated at the same time using a z-score approach (for example, see Graph 2 infra).

Using actual data for the prior 10-year period, the difference in performance between these two companies can be illustrated. On days when these stocks moved higher, Coca-Cola (KO) moved 0.76% higher on average. Tesla (TSLA), on the other hand, moved higher 2.54% on average. That means when the stocks traded higher, Tesla moved 3.3× what Coca-Cola moved on a given day.

Looking a bit deeper into the data, a TRADR (TRS) relevance score is used to compare these different companies on an even footing. Table 1 illustrates TRADR relevance scores for each tenth percentile for both positive and negative moves. Table 1 helps to accentuate the difference between these two companies and the value the TRS can provide. For example, a TRS of 100 would constitute a 24.5% move in a given day for Tesla, but only a 6.5% move for Coca-Cola. The table below clearly accentuates the difference between nominal data and data relative to the available historical data.

TABLE 1

| TRS | SYMBOL | % MOVE |
|---|---|---|
| 100 | KO | 6.5% |
| 90 | KO | 1.6% |
| 80 | KO | 1.2% |
| 70 | KO | 0.9% |
| 60 | KO | 0.7% |
| 50 | KO | 0.6% |
| 40 | KO | 0.4% |
| 30 | KO | 0.3% |
| 20 | KO | 0.2% |
| 10 | KO | 0.1% |
| 0 | KO | 0.0% |
| 10 | KO | −0.1% |
| 20 | KO | −0.2% |
| 30 | KO | −0.3% |
| 40 | KO | −0.4% |
| 50 | KO | −0.5% |
| 60 | KO | −0.7% |
| 70 | KO | −0.9% |
| 80 | KO | −1.1% |
| 90 | KO | −1.7% |
| 100 | KO | −9.7% |
| 100 | TSLA | 24.5% |
| 90 | TSLA | 5.6% |
| 80 | TSLA | 3.7% |
| 70 | TSLA | 2.8% |
| 60 | TSLA | 2.3% |
| 50 | TSLA | 1.8% |
| 40 | TSLA | 1.4% |
| 30 | TSLA | 1.0% |
| 20 | TSLA | 0.6% |
| 10 | TSLA | 0.3% |
| 0 | TSLA | 0.0% |
| 10 | TSLA | −0.3% |
| 20 | TSLA | −0.5% |
| 30 | TSLA | −0.8% |
| 40 | TSLA | −1.1% |
| 50 | TSLA | −1.6% |
| 60 | TSLA | −2.0% |
| 70 | TSLA | −2.7% |
| 80 | TSLA | −3.4% |
| 90 | TSLA | −5.0% |
| 100 | TSLA | −21.1% |

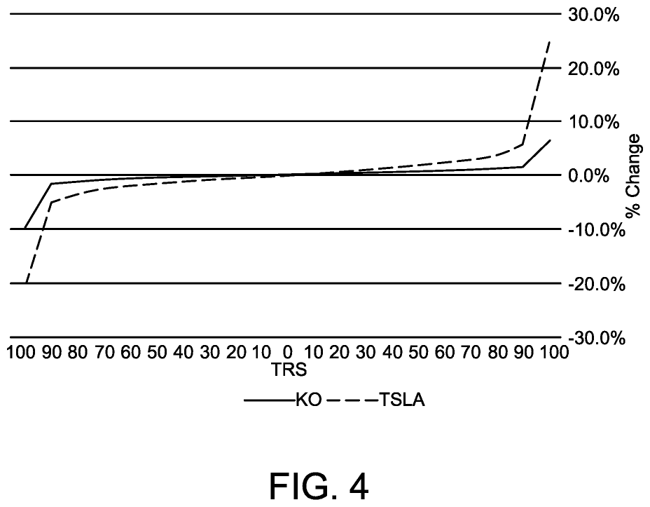

The two companies may also be compared using the same percentage move to accentuate the difference in TRS. For example, a 2% move for Coca-Cola, would constitute a TRS of 95—quite a significant move. A 2% move for Tesla, meanwhile, would only constitute a TRS of 56. This helps to highlight how a nominal percentage move can be a very inconsistent means for comparing data across securities. FIG. 4 represents this data visually. This shows visually how the performance of the two companies skews quite differently. This also helps to emphasize the point that a nominal percentage alone is not the best means for comparing different securities.

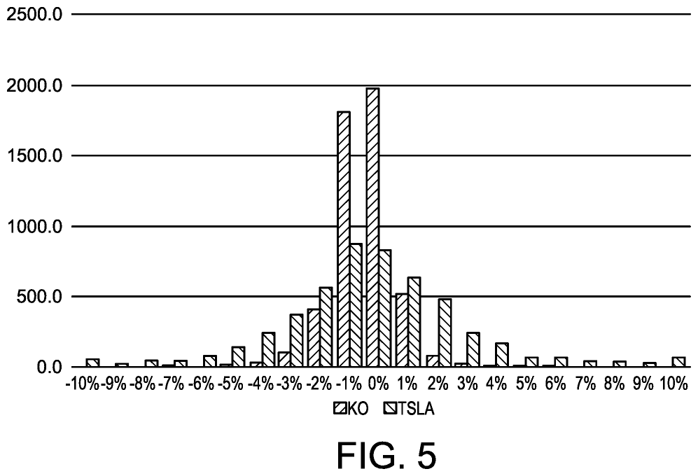

The histogram illustrated in FIG. 5 also helps to highlight the differences in performance between these two companies. The histogram shows the number of days recorded for each percentage move for both companies. Coca-Cola, shown in blue, is much more highly concentrated in the middle of the chart. This means that on most days, Coca-Cola tends to move only a percent or two. Tesla, on the other hand, is less concentrated in the middle and is more distributed, even out to the extremes at +/−10%. This means that Tesla experiences much large swings in price than Coca-Cola.

Case 2 Volume (Absolute), Equities

Volume is the number of shares that were traded in a given day for a given security. One might instinctively assume that a big change in price would be accompanied by large volume, but that is not necessarily the case. In fact, the TRS for 1-day percentage change in price and the TRS for absolute volume are actually very loosely correlated. This lack of correlation means these two metrics convey very different things and overlap only in certain instances. Table 2 shows these correlations for 5 large companies.

TABLE 2

| SYMBOL | CORRELATION |
|---|---|
| AAPL | 0.30 |
| JPM | 0.17 |
| DIS | 0.26 |
| MSFT | 0.40 |
| V | 0.46 |

In some cases, a lack of volume can lead to large price swings because there are an insufficient number of buyers participating in the market for a given security. In other instances, a security may have high volume, but the price does not move much. This may be a sign that a trend is continuing and more participants are beginning to transact in a given security. Lastly, a security with a large percentage change and high volume would be of especially high relevance as it may signal a newsworthy development or a change in trend. As such, these two metrics each provide useful information to the end user. By combining multiple metrics into a multi-factor feed, the method can provide greater value to the end user than each metric might on its own. Such a feed might provide better depth and clarity to users than a single-factor feed, depending on the situation.

Case 3 Standard Deviation.

As discussed supra, the method is used to populate a relevance-driven feed. Key to that method is the TRADR relevance score (TRS), a round number between 0 and 100, that expresses the degree of statistical extremity of the current value relative to the historical data. The TRS provides a clear, simple, and consistent metric that instantly provides context across all combinations of monitored securities, monitored series, and monitored metrics. The TRS adjusts for the different distributions of data observed across all combinations of monitored securities/series/metrics/time periods. The TRS is also the key input used by the method to generate various relevance-driven feeds, in either a single-factor (one specific TRS) or multi-factor (multiple weighted TRS) manner.

This example serves to highlight how different statistical methods could be used to achieve the same outcome. The purpose of this is to show that the method outlined in this application for populating a relevance-driven feed is not dependent on one particular statistical method. In the present invention, the key elements are the relevance score and the manner in which it is used to create a relevance-driven feed. The method does not rely on a sole statistical method for calculating the relevance score as there are multiple approaches that could achieve the same result.

The preferred statistical method used in implementing this method for a relevance-driven feed is percentile rank. Another approach could utilize standard deviation from the mean. Using this statistical method, the mean value and standard deviation would be calculated for the available historical data. A z-score could then be calculated that shows for a given metric, showing how many standard deviations from the mean a given value is. Table 3 below uses Tesla again for the example. It shows 1-day percentage changes, the TRS value (using percentile rank), and the z-score (using standard from the mean).

TABLE 3

| SYMBOL | TRS | CHANGE | ZSCORE |
|---|---|---|---|
| TSLA | 100 | 24.5% | 6.95 |
| TSLA | 90 | 5.6% | 1.53 |
| TSLA | 80 | 3.7% | 0.99 |
| TSLA | 70 | 2.8% | 0.73 |
| TSLA | 60 | 2.3% | 0.57 |
| TSLA | 50 | 1.8% | 0.44 |
| TSLA | 40 | 1.4% | 0.32 |
| TSLA | 30 | 1.0% | 0.20 |
| TSLA | 20 | 0.6% | 0.10 |
| TSLA | 10 | 0.3% | 0.01 |
| TSLA | 0 | 0.0% | −0.07 |
| TSLA | 10 | −0.3% | −0.15 |
| TSLA | 20 | −0.5% | −0.22 |
| TSLA | 30 | −0.8% | −0.30 |
| TSLA | 40 | −1.1% | −0.39 |
| TSLA | 50 | −1.5% | −0.51 |
| TSLA | 60 | −2.0% | −0.64 |
| TSLA | 70 | −2.6% | −0.81 |
| TSLA | 80 | −3.3% | −1.03 |
| TSLA | 90 | −4.7% | −1.42 |
| TSLA | 100 | −14.3% | −4.17 |

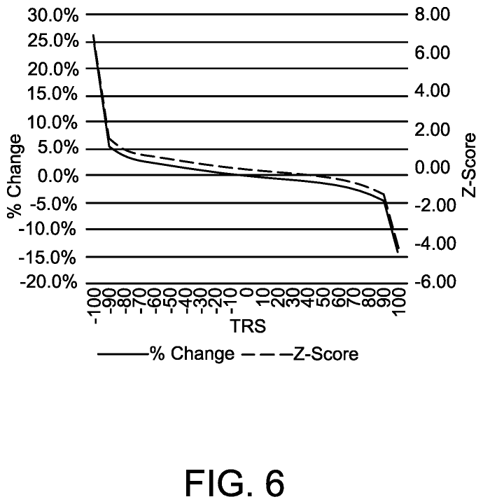

This data can also be represented visually. FIG. 6 shows the interplay between the 1-day percent change, the z-score, and the TRS calculated using percentile rank. They all move exactly in lockstep. This helps to illustrate how multiple different statistical methods could be used to arrive at the same TRS.

The exact method of calculating a relevance score is based on the monitored metric. Since not all metrics measure data the same way, the approach may be slightly different in certain cases. In some cases, very high and very low values would both be deemed relevant. In other cases, only high values may be of relevance. In addition to relevance scores calculated for individual securities, relevance scores can also be calculated for groups of securities. In some cases, individual securities may be aggregated before calculating a group relevance score. This may include equity indices, sectors, or proprietarily defined groups. In other cases, relevance scores may be calculated before aggregating data. An example might be for looking at the breadth of relevance which is the number of securities within a given sector are registering high relevance scores.

Table 4 is exemplary of a plurality of possible monitored metric calculations for the method.

TABLE 4

| CATEGORY | SUBCATEGORY | METRIC | TIME PERIOD | |
|---|---|---|---|---|
| MARKET | PRICE | % CHANGE | 1 | DAY |
| | | | 2 | DAY |
| | | | 3 | DAY |
| | | | 4 | DAY |
| | | | 5 | DAY |
| | PRICE | DAY RANGE | 1 | DAY |
| | PRICE | % FROM SMA | 20 | DAY |
| | | | 50 | DAY |
| | | | 100 | DAY |
| | | | 200 | DAY |
| | VOLUME | ABSOLUTE (HIGH) | 1 | DAY |
| | | ABSOLUTE (LOW) | 1 | DAY |
| | VOLUME | % CHANGE D/D | 1 | DAY |
| | | % CHANGE W/W | 1 | WEEK |
| | | % CHANGE M/M | 1 | MONTH |
| | VOLUME | % FROM SMA | 20 | DAY |
| | | | 50 | DAY |
| | | | 100 | DAY |
| | | | 200 | DAY |
| FUNDAMENTAL | VALUATION | P/E | 1 | DAY |
| | | P/B | 1 | DAY |
| | | P/S | 1 | DAY |
| | | PEG | 1 | DAY |
| | REVENUE | % CHANGE Q/Q | 1 | QUARTER |
| | | % CHANGE Y/Y | 1 | YEAR |
| | | INFLECTION + TO − | | |
| | | INFLECTION − TO + | | |
| | EARNINGS | % CHANGE Q/Q | 1 | QUARTER |
| | | % CHANGE Y/Y | 1 | YEAR |
| | | INFLECTION + TO − | | |
| | | INFLECTION − TO + | | |
| | CAPEX? | % CHANGE Q/Q | 1 | QUARTER |
| | CASH FLOW? | % CHANGE Y/Y | 1 | YEAR |
| | | INFLECTION + TO − | | |
| | | INFLECTION − TO + | | |
| PERFORMANCE | PERFORMANCE | % CHANGE W/W | 1 | WEEK |
| | | % CHANGE M/M | 1 | MONTH |
| | | % CHANGE Q/Q | 1 | QUARTER |
| | | % CHANGE Y/Y | 1 | YEAR |
| TECHNICAL | RSI | RSI | DAILY | |
| | | | WEEKLY | |
| | | | MONTHLY | |
| | | | QUARTERLY | |
| | Δ FROM SMA (%) | Δ FROM SMA (%) | 20 | DAY |
| | | | 50 | DAY |
| | | | 100 | DAY |
| | | | 200 | DAY |

| | | | |
|---|---|---|---|
| | BOLLINGER BAND | BREAKOUT/BREAKDOWN | DAILY/WEEKLY/MONTHLY |
| | | % ABOVE/BELOW BB | DAILY/WEEKLY/MONTHLY |
| | SIMPLE MOVING AVERAGE | INFLECTION | DAILY/WEEKLY/MONTHLY |
| | | CROSSOVERS | DAILY/WEEKLY/MONTHLY |
| | TREND | TREND | DAILY/WEEKLY/MONTHLY |
| BREADTH | ADVANCE/DECLINE | WITHIN INDEX | DAILY/WEEKLY/MONTHLY |
| | | WITHIN SECTOR | DAILY/WEEKLY/MONTHLY |
| | UP/DOWN VOLUME | WITHIN INDEX | DAILY/WEEKLY/MONTHLY |
| | | WITHIN SECTOR | DAILY/WEEKLY/MONTHLY |
| | #/% ABOVE SMA | 20 DAY SMA | DAILY/WEEKLY/MONTHLY |
| | | 50 DAY SMA | DAILY/WEEKLY/MONTHLY |
| | | 100 DAY SMA | DAILY/WEEKLY/MONTHLY |
| | | 200 DAY SMA | DAILY/WEEKLY/MONTHLY |
| | OVERBOUGHT/OVERSOLD | % OF RSI ABOVE 70 | DAILY/WEEKLY/MONTHLY |
| | | % OF RSI BELOW 30 | DAILY/WEEKLY/MONTHLY |

The algo layer is the final step in the method. After all the relevance scores have been calculated, the scores can be used to generate an ordered list. The natural implementation is a list in descending order of relevance, surfacing the most relevant data to the top. The ordered list, though, can be created using a single factor or multiple factors. A single-factor list would be driven by a metric such as one day percentage change in price. A multi-factor list may incorporate additional factors such as one day volume as well.

The method could be used to generate a number of different feed styles focusing on different asset classes, thematic investing styles, or other aspects of financial markets data. The method may comprise a plurality of feeds.

A macro feed would be a feed that follows core macro factors such as interest rates, equity indices, commodities, foreign exchange, and economic data points. This would effectively be a core feed and most powerful implementation of this method as it would allow users to monitor multiple asset classes in multiple countries as well as economic data.

A performance feed would be a feed that monitors performance across different asset classes and different time horizons. An example might be highlighting the assets that performed best relative to their historical performance over a given time period (week, month, quarter, year, etc.).

An economic feed would be a feed that monitors recent economic data releases, highlights the most relevant releases, and puts the data into context relative to the available historical data.

A technical feed would be a feed that monitors technical analysis studies across different securities or asset classes, highlights the most relevant patterns or technical readings, and puts the data into context relative to the available historical data.

A fundamental feed would be a feed that monitors fundamental data across companies, sectors, or indices, highlights changes in fundamental factors such as earnings, revenue, capex, etc., and puts the data into context relative to the available historical data.

A breadth feed would be a feed that monitors breadth conditions across asset classes, indices and sectors, highlights how broad participation in a given move is, such as number of advancing/declining stocks, advancing/declining sectors, new highs/lows, volume, etc., and puts the data into context relative to the available historical data.

A bullish feed would be a feed that monitors bullish factors across different asset classes, highlights the most relevant bullish indicators, and puts the data into context relative to the available historical data.

A bearish feed would be a feed that monitors bearish factors across different asset classes, highlights the most relevant bearish indicators, and puts the data into context relative to the available historical data.

An international feed would be a feed that monitors performance, technical, and economic factors, highlights the most relevant data points pertaining to international securities and economic data, and puts the data into context relative to the available historical data.

A master feed would be a feed that monitors all securities, series, and metrics, highlights the most relevant data, and puts the data into context relative to the available historical data. This would be the most all-encompassing implementation of this technology.

The following examples illustrate how the plurality of feeds would surface data and the value they could provide to the end user using Symbol Key 1. Below are examples showing what the sample output would look like from a single-factor macro-focused feed. These examples are based on actual data from 1991 (or earliest available) through 12/31/2020. The fields displayed in an actual production application may differ from the fields displayed in these examples. The legend below shows the securities and indices used in the examples.

| | | | | |
|---|---|---|---|---|
| SYMBOL | CLOSE | PRIOR_CLOSE | 1_DAY_%_CHANGE | TRS |

EXAMPLE 1- Mar. 16, 2020
MASSIVE MARKET SELLOFF AMISDT HEIGHT OF COVID 19 LIQUIDITY SHOCK
IN THIS SCENARIO, THE TRADR FEED WOULD HIGHLIGHT THE SEVERITY OF THE SELLOFF
ALMOST EVERY MONITORED METRIC IN THIS EXAMPLE IS REGISTERING 100TH PERCENTILE
READINGS

| | | | | |
|---|---|---|---|---|
| VXN | 80.08 | 51.84 | 54.48% | 100 |
| VIX | 82.69 | 57.83 | 42.99% | 100 |
| TNX | 7.28 | 9.51 | −23.45% | 100 |
| RUT | 1,037.41 | 1,210.13 | −14.27% | 100 |
| TYX | 13.34 | 15.52 | −14.05% | 100 |
| USO | 48.40 | 55.68 | −13.08% | 100 |
| SLV | 12.00 | 13.69 | −12.35% | 100 |
| NDX | 7,020.37 | 7,995.26 | −12.19% | 100 |
| SPX | 2,386.13 | 2,711.02 | −11.98% | 100 |
| UUP | 26.56 | 27.44 | −3.21% | 100 |
| GBTC | 5.53 | 6.32 | −12.50% | 96 |
| GLD | 141.64 | 143.28 | −1.15% | 77 |

EXAMPLE 2- Mar. 18, 2020
ANOTHER EXAMPLE FROM THE VERY VOLATILE DAYS OF COVID 19 LIQUITY SHOCK
TREASURY YIELDS REBOUNDED VIOLENTLY AFTER SELLING OFF MASSIVELY JUST PRIOR OIL
SUFFERED A MASSIVE 17.5% DECLINE
IMPORTANCE HERE IS THAT CLEARLY THERE ARE MAJOR MOVES HAPPENING, BUT TO DIFFERENT
DEGREES THIS IS THE MOVES.
THE KEY USE CASE SCENARIO FOR TRADR, EVEN ON A CRAZY DAY WHEN THERE ARE LOTS OF
THINGS MOVING, THE FEED IS HIGHLIGHTING WHAT IS MOST RELEVANT AND PROVIDING
CONTEXT FOR ALL
VOLATILITY (VIX) FOR EXAMPLE, DID NOT MOVE MUCH ON THIS DAY, ONLY REGISTERING A
TRS OF 13

| | | | | |
|---|---|---|---|---|
| TNX | 12.66 | 9.97 | 26.98% | 100 |
| TYX | 18.97 | 15.82 | 19.91% | 100 |
| USO | 37.68 | 45.68 | −17.51% | 100 |
| RUT | 991.16 | 1,106.50 | −10.42% | 100 |
| SPX | 2,398.10 | 2,529.19 | −5.18% | 99 |
| UUP | 27.44 | 27.03 | 1.52% | 99 |
| SLV | 11.21 | 11.88 | −5.64% | 98 |
| NDX | 7,175.17 | 7,473.95 | −4.00% | 96 |
| GLD | 140.70 | 143.56 | −1.99% | 92 |
| VXN | 74.22 | 71.55 | 3.73% | 57 |
| GBTC | 6.01 | 6.10 | −1.48% | 19 |
| VIX | 76.45 | 75.91 | 0.71% | 13 |

EXAMPLE 3- May 4, 2017
ON THIS DAY, EQUITY MARKETS ARE VERY TAME, SPX/NDX/RUT ALL BELOW 15
OIL WAS THE MOST RELEVANT MOVE ON THE DAY WITH A 95 TRS FOR ITS 4.7% DECLINE
TRADR FEED WOULD ALSO HIGHLIGHT MOVES IN THE DOLLAR, TREASURIES, AND PRECIOUS
METALS AS FAIRLY RELEVANT

| | | | | |
|---|---|---|---|---|
| USO | 75.68 | 79.44 | −4.73% | 95 |
| UUP | 25.49 | 25.65 | −0.62% | 81 |
| TNX | 23.56 | 23.09 | 2.04% | 77 |
| TYX | 29.99 | 29.55 | 1.49% | 76 |
| GLD | 116.79 | 117.98 | −1.01% | 73 |
| SLV | 15.43 | 15.59 | −1.03% | 53 |
| GBTC | 1.86 | 1.82 | 2.20% | 42 |
| VIX | 10.46 | 10.68 | −2.06% | 31 |
| VXN | 12.18 | 11.98 | 1.67% | 31 |
| RUT | 1,388.84 | 1,390.92 | −0.15% | 12 |
| SPX | 2,389.52 | 2,388.13 | 0.06% | 7 |
| NDX | 5,626.31 | 5,625.15 | 0.02% | 2 |

EXAMPLE 4- Jun. 8, 2018
THIS WAS A FAIRLY BENIGN DAY IN MARKETS BROADLY WITH AN AVERAGE TRS OF 15
ACROSS ALL SECURITIES
IN THIS EXAMPLES TRADR WOULD HIGHLIGHT THE FACT THAT MARKETS ARE QUIET WITH
DEMURE MOVES
IT WOULD ALSO STILL PROVIDE CONTEXT WITHIN A QUIET DAY OF WHO THE BIGGEST
RELATIVE MOVERS WERE

| | | | | |
|---|---|---|---|---|
| SPX | 2,779.03 | 2,770.37 | 0.31% | 34 |
| USO | 106.16 | 106.80 | −0.60% | 28 |
| SLV | 15.78 | 15.72 | 0.38% | 25 |
| RUT | 1,672.49 | 1,667.77 | 0.28% | 20 |
| GBTC | 12.70 | 12.86 | −1.24% | 16 |
| GLD | 123.01 | 122.86 | 0.12% | 13 |
| UUP | 24.64 | 24.63 | 0.04% | 12 |
| TNX | 29.37 | 29.33 | 0.14% | 10 |
| VXN | 16.51 | 16.45 | 0.37% | 9 |
| VIX | 12.18 | 12.13 | 0.41% | 7 |
| TYX | 30.82 | 30.80 | 0.07% | 6 |
| NDX | 7,152.62 | 7,152.83 | 0.00% | 0 |

SYMBOL KEY 1
LEGEND

| | |
|---|---|
| SYMBOL | SECURITY NAME |
| GBTC | BITCOIN ETN |
| GLD | GOLD ETF |
| NDX | NASDAQ 100 ETF |
| RUT | RUSSELL 2000 ETF |
| SLV | SILVER ETF |
| SPX | S&P500 ETF |
| TNX | 10 YEAR TREASURY YIELD INDEX |
| TYX | 30 YEAR TREASURY YIELD INDEX |
| USO | OIL ETF |
| UUP | US DOLLAR ETF |
| VIX | S&P 500 VOLATILITY INDEX |
| VXN | NASDAQ 100 VOLATILITY INDEX |

The following additional examples illustrate how the plurality of feeds would surface data and the value they could provide to the end user using Symbol Key 2. Below are examples showing what the sample output would look like from a single-factor equity-focused feed. These examples are based on actual data from 1991 (or earliest available) through 12/31/2020. The fields displayed in an actual production application may differ from the fields displayed in these examples. The legend below shows the securities and indices used in the examples.

| | | | | |
|---|---|---|---|---|
| SYMBOL | CLOSE | PRIOR_CLOSE | 1_DAY_%_CHANGE | TRS |

EXAMPLE 1- Nov. 20, 2008
DURING THE HEIGHT OF THE FINANCIAL CRISIS, SEVERAL BANK STOCKS REGISTERED 100
TRS READINGS
THE EXAMPLE HIGHLIGHTS THE TRADR FEEDS ABILITY TO HIGHLIGHT WHICH SECTORS ARE
MOVING AS A GROUP
CITIGROUP, JP MORGAN, AND BANK OF AMERICA ARE ALL REGISTERING 100 TRS READINS
WITH DOUBLE DIGIT PRICE DECLINES

| | | | | |
|---|---|---|---|---|
| C | 47.1 | 64.5 | −26.98% | 100 |
| JPM | 23.38 | 28.47 | −17.88% | 100 |
| BAC | 11.25 | 13.06 | −13.86% | 100 |
| ABT | 24.09 | 26.08 | −7.63% | 100 |
| V | 12.03 | 12.89 | −6.67% | 99 |
| DIS | 18.73 | 19.94 | −6.07% | 99 |
| MCD | 52.91 | 55.44 | −4.56% | 99 |
| JNJ | 55.81 | 58.12 | −3.98% | 99 |
| AAPL | 2.87 | 3.08 | −6.82% | 97 |
| MSFT | 17.53 | 18.29 | −4.16% | 96 |
| CRM | 5.7 | 5.49 | 3.83% | 88 |
| VZ | 26.5 | 26.94 | −1.63% | 78 |
| BA | 37.11 | 37.48 | −0.99% | 49 |

EXAMPLE 2- Oct. 6, 2017
THIS EXAMPLE HIGHLIGHTS HOW THE TRADR FEED WILL SURFACE INDIVIDUAL STOCKS OF
RELEVANCE
ON AN OTHERWISE BENIGN DAY FOR MARKETS, VERIZON REGISTERED AN 84 TRS RELATED
TO A DIVIDEND ANNOUNCEMENT
OUTSIDE OF VERIZON'S MOVE ON THIS DAY, MOST STOCKS WERE LARGELEY UNCHANGED

| | | | | |
|---|---|---|---|---|
| VZ | 48.81 | 49.77 | −1.93% | 84 |
| MCD | 159.6 | 158.8 | 0.50% | 37 |
| V | 106.73 | 106.24 | 0.46% | 28 |
| CRM | 96.32 | 95.73 | 0.62% | 27 |
| BAC | 26.21 | 26.13 | 0.31% | 19 |
| TSLA | 71.37 | 71.06 | 0.44% | 15 |
| ABT | 55 | 54.92 | 0.15% | 13 |
| JPM | 96.92 | 97.09 | −0.18% | 9 |
| MSFT | 76 | 75.97 | 0.04% | 7 |
| BA | 258.58 | 258.89 | −0.12% | 5 |
| JNJ | 133.22 | 133.19 | 0.02% | 5 |
| C | 75.64 | 75.72 | −0.11% | 3 |
| AAPL | 38.82 | 38.84 | −0.05% | 1 |
| DIS | 100.07 | 100.11 | −0.04% | 1 |

EXAMPLE 3- May 9, 2013
HERE IS ANOTHER EXAMPLE OF HOW THE TRADR FEED WILL SURFACE INDIVIDUAL STOCKS
OF RELEVANCE
ON THIS DAYTESLA WAS UP 25% REIGSTERING A TRS OF 100, VASTLY HIGHER THAN OTHER
STOCKS IN THE FEED
THIS WAS THE DAY FOLLOWING THE COMPANY'S EARNINGS CALL THE PREVIOUS NIGHT

| | | | | |
|---|---|---|---|---|
| TSLA | 13.88 | 11.15 | 24.48% | 100 |
| MCD | 99.69 | 100.95 | −1.25% | 69 |
| CRM | 43.15 | 42.37 | 1.84% | 64 |
| JPM | 49.04 | 49.76 | −1.45% | 63 |
| C | 48.6 | 49.29 | −1.40% | 60 |
| DIS | 66.67 | 65.99 | 1.03% | 55 |
| MSFT | 32.66 | 32.99 | −1.00% | 51 |
| VZ | 52.71 | 53.11 | −0.75% | 47 |
| AAPL | 16.31 | 16.56 | −1.51% | 43 |
| BAC | 12.91 | 13.02 | −0.85% | 43 |
| BA | 94.61 | 94.04 | 0.61% | 34 |
| JNJ | 85.15 | 85.46 | −0.36% | 31 |
| V | 44.64 | 44.81 | −0.38% | 25 |
| ABT | 36.18 | 36.29 | −0.30% | 18 |

EXAMPLE 4- Jun. 24, 2015
THIS EXAMPLE HIGHLIGHT HOW THE TRADR FEED PROVIDES CONTEXT ON A DAY WHEN
MOST COMPANYS ARE PERFORMING SIMILARLY
ON A DAY LIKE THIS, IT WOULD BE HARD TO DISCERN RELEVANCE WITH MOST STOCKS
TRADING SIMILARLY
THE TRADR FEED SIFTS THROUGH THE PERFORMANCE TO HIGHLIGHT RELATIVE PERFORMANCE

| | | | | |
|---|---|---|---|---|
| VZ | 47.29 | 47.77 | −1.01% | 58 |
| C | 56.66 | 57.39 | −1.27% | 56 |
| JPM | 69.02 | 69.75 | −1.05% | 50 |
| BAC | 17.49 | 17.67 | −1.02% | 50 |
| AAPL | 32.02 | 31.75 | 0.85% | 50 |
| BA | 143 | 144.43 | −0.99% | 49 |
| V | 68.86 | 69.42 | −0.81% | 47 |
| ABT | 49.5 | 49.88 | −0.76% | 45 |
| CRM | 73.5 | 74.2 | −0.94% | 41 |
| MCD | 96.64 | 97.18 | −0.56% | 37 |
| JNJ | 99.33 | 99.78 | −0.45% | 37 |
| MSFT | 45.63 | 45.91 | −0.61% | 34 |
| TSLA | 53.03 | 53.53 | −0.93% | 33 |
| DIS | 113.77 | 114.41 | −0.56% | 32 |

SYMBOL KEY 2
LEGEND

| | |
|---|---|
| SYMBOL | SECURITY NAME |
| TSLA | TESLA |
| MCD | MCDONALDS |
| CRM | SALSEFORCE |
| JPM | JPMORGAN |
| C | CITIGROUP |
| DIS | DISNEY |
| MSFT | MICROSOFT |
| VZ | VERIZON |
| AAPL | APPLE |
| BAC | BANK OF AMERICA |
| BA | BOEING |
| JNJ | JONHSON & JOHNSON |
| V | VISA |
| ABT | ABBOTT LABS |

Below are additional examples showing what the sample output would look like from feeds incorporating monitored series in addition to monitored securities. The monitored metrics for economic data series will primarily focus on one of two approaches for quantifying the data. First, the degree of statistical deviation from the mean in absolute terms. Second, the degree of statical deviation from the mean in relative terms (rate of change). Using the number of initial jobless claims as an example, we can illustrate how both approaches are unique and appropriate. Assume initial jobless claims, on average, are 150,000/week. If we enter a period where initial jobless claims skyrocket to say, 800,000 per week, then that absolute value is of great import as it is a significant deviation from the historical mean. Another way of examining this data, though, would be to look at the rate of change in the data. Assume that on average that the number of initial jobless claims changes by 3-5% week-over-week. If we suddenly see a week in which initial jobless claims increase by 25%, that would also be of great import as the rate of change in the data is also a significant deviation from the historical mean. Both approaches provide similar, yet different, insights into the underlying data series. The first approach provides insight into the data as it currently exists, the second approach provides insight into how rapidly the data is improving or weakening relative to previous readings.

The first example below is illustrative of how monitored series might be incorporated into a broader feed with monitored securities. In this type of scenario, monitored series might be sorted in a broader feed based on their TRS on the day the data is released for the monitored series. As mentioned above, the TRS for monitored series would most likely be based on the rate of change in the series, the absolute value relative to the available historical data, or both. Example 1 is based off of actual data from 1991 (or earliest available) through Dec. 31, 2020, using the rate of change in the series to calculate the TRS.

EXAMPLE 1 -May 15, 2020
ECONOMIC DATA RELEASES FROM THE CURRENT DAY ARE USED
TO SUPPLEMENT OTHER FEEDS OF MONITORED SECURITIES
IN THIS EXAMPLE, RETAIL SALES WERE RELEASED FOR THE MONTH
OF APRIL, SHOWING A 12.66% DECLINE FROM MARCH TO APRIL
THIS DECLINE WAS THE LARGEST PERCENTAGE DECLINE IN OUR
DATA SET, REGISTERING A TRS OF 100ON THIS DAY, IT
WOULD HAVE BEEN THE MOST SIGNIFICANT MOVE BY TRS, WHEN
COMPARED TO DATA IN THE MACRO FEED
THE RETAIL SALES DATA WOULD HAVE BEEN USED TO SUPPLEMENT
OTHER FEEDS, SUCH AS THE MACRO DATA FEED

| SYMBOL | CLOSE | PRIOR_CLOSE | 1_DAY_%_CHANGE | TRS |
|---|---|---|---|---|
| RETAIL SALES | | | −12.66% | 100 |
| SLV | 15.51 | 14.81 | 4.73% | 98 |
| USO | 22.39 | 21.45 | 4.38% | 95 |
| TNX | 6.4 | 6.19 | 3.39% | 92 |
| TYX | 13.19 | 12.96 | 1.78% | 83 |
| RUT | 1257 | 1237.55 | 1.57% | 81 |
| GBTC | 11.05 | 11.8 | −6.36% | 80 |
| GDL | 163.93 | 163.01 | 0.56% | 49 |
| NDX | 9152.6 | 9094.42 | 0.64% | 44 |
| SPX | 2863.7 | 2852.5 | 0.39% | 40 |
| VIX | 31.89 | 32.61 | −2.21% | 34 |
| UUP | 27.18 | 27.16 | 0.07% | 16 |
| VXN | 33.49 | 33.79 | −0.89% | 15 |

The second example below is illustrative of what an economic feed might look like. The structure and function of an economic feed would be slightly different than previous examples. With monitored securities, there are multiple securities generating data throughout each trading day. Monitored series, on the other hand, are updated once at a set frequency—weekly, monthly, quarterly, etc. As such it is not possible to generate a feed in the same way. The most logical implantation would be a feed that looks back over a specific time period, such as the prior week or month. The economic feed would then be comprised of any monitored series released during that time period and highlight the most relevant releases and put recent references into context relative to the available historical data. Example two uses hypothetical data, is for illustrative purposes.

EXAMPLE 2- HYPOTHETICAL DATA
THE DATA IN THIS EXAMPLE IS HYPOTHETICAL AND FOR
ILLUSTRATIVE PURPOSES FOR THE PROVISIONAL PATENT
FILING
THIS EXAMPLE WILL BE UPDATED BASED ON ACTUAL DATA
FOR THE ACTUAL PATENT FILING
AN ECONOMIC DATA FEED WOULD MONITOR RECENT
ECONOMIC DATA RELEASES AND HIGHLIGHT THE MOST
RELEVANT
BECAUSE ECONOMIC DATA IS RELEASED LESS FREQUENTLY,
THE FEED WOULD NEED TO LOOK BACK AT THE PAST WEEK
OR MONTH
THIS FEED COULD HIGHLIGHT ABSOLUTE VALUES, RATE OF
CHANGE, OR BOTH

| SERIES | RATE OF CHANGE | TRS |
|---|---|---|
| INITIAL JOBLESS CLAIMS | 16% | 96 |
| RETAIL SALES | −11% | 94 |
| NONFARM PAYROLLS | −8% | 91 |
| HOUSING STARTS | −6% | 82 |
| ISM NON-MANUFACTURING PMI | −10% | 79 |
| DURABLE GOODS | −4% | 51 |
| GDP GROWTH | 1% | 31 |
| ISM SERVICES PMI | 0% | 12 |

The following charts are exemplary of the illustrated process.

CHART 1
PROCESS OVERVIEW
DATA LAYER

THE DATA LAYER IMPORTS ALL OF THE NECESSARY DATA
INTO THE PROCESS. INCLUDING, BUT NOT LIMITED, TO...
CURRENT VALUES FOR MONITORED SECURITIES/SERIES
HISTORICAL DATA FOR MONITORED SECURITIES/SERIES
APPLICABLE MONITORED METRICS FOR EACH MONITORED
SECURITY/SERIES
APPLICABLE TIME INTERVALS FOR EACH MONITORED METRIC
WEIGHTINGS FOR COMPONENTS OF INDICES, SECTORS,
GROUPS, ETC

CHART 2
PROCESS OVERVIEW
COMPUTE LAYER

THE COMPUTER LAYER TAKES ALL OF THE INPUT DATA FROM
THE DATA LAYER AND COMPUTES...
EACH APPLICABLE MONITORED METRIC (1 DAY % CHANGE,
RSI, 1 WEEK PERFORMANCE, ETC.
FOR EACH MONITORED SECURITY/SERIES (APPLE INC., S&P
500, RETAIL SALES, VIX, ETC.)
FOR EACH APPLICABLE TIME SERIES (1 DAY, 1 WEEK, 1
MONTH, 3 MONTHS, ETC.)
EACH CALCULATION CREATES A TRADR RELEVANCE SCORE
(TRS) FOR ANY GIVEN COMBINATION OF...
INDIVIDUAL SECURITIES/SERIES OR GROUPS OF
SECURITIES/SERIES
MONITORED METRIC
MONITORED SECURITY/SERIES
TIME SERIES
TRS CALCULATIONS ARE DETERMINED BY THE APPROPRIATE
STATISTICAL METHOD...
PERCENTILE RANK
STANDARD DEVIATION FROM THE MEAN
OTHER APPLICABLE STATISTICAL METHODS

CHART 3
PROCESS OVERVIEW
COMPUTE LAYER
EXAMPLE:

| | |
|---|---|
| MONITORED SECURITY: | APPLE INC |
| MONITORED METRIC: | 1 DAY PRICE % CHANGE |
| TIME PERIOD: | 10 YEARS |
| STATISTICAL METHOD: | PERCENTILE RANK |

IN THIS EXAMPLE, THE TRADR RELEVANCE SCORE
WOULD COMPARE APPLE'S 1 DAY PRICE % CHANGE
TO ALL OF THE PRIOR 1 DAY PRICE % CHANGES OVER
THE 10 YEAR TIME PERIOD. USING A PERCENTILE
RANK CALCULATION, A GIVEN DAY'S OBSERVATION
WOULD BE IN THE X PERCENTILE OF HISTORICAL DATA

CHART 4
PROCESS OVERVIEW
ALGO LAYER

THE ALGO LAYER TAKES THE COMPUTED RELEVANCE SCORES
AND ASSEMBLES THEM INTO RELEVANCE BASED FEEDS
EACH MONITORED SECURITY OR SERIES MAY BE USED IN ONE
OR MULTIPLE FEEDS
A COMPANY LIKE APPLE WOULD INCLUDED IN MULTIPLE
FEEDS...
S&P 500 INDEX COMPONENTS
NASDAQ 100 INDEX COMPONENTS
S&P 500 TECHNOLOGY SECTOR
TRADR PROPRITARY GROUPINGS SUCH AS ‘MEGA CAP TECH’,
‘COMPUTER
MANUFACTURERS’, ETC.
EACH FEED WOULD BE DIFFERENT BASED ITS COMPONENT
SECURITIES/SERIES
FEEDS MAY BE GENERATED USING A SINGLE FACTOR SUCH
AS 1 DAY % CHANGE
FEEDS MAY ALSO BE GENERATED USING A WEIGHTED MULTI-
FACTOR APPROACH THAT IS DRIVEN BY MULTIPLE TRS

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of generating a relevance-driven feed for financial market data on a computer-based system accessible via a user input connected to the computer-based system over a network comprising the steps of:
importing a plurality of inputs of financial market data for a monitored item;
creating a data layer from the plurality of inputs of financial market data;
generating a plurality of relevance scores from the plurality of inputs, each of the plurality of relevance scores based on a unique combination of the plurality of inputs;
creating an ordered relevance list of the plurality of relevance scores;
updating the ordered relevance list as new relevance scores are generated;
generating the relevance-driven feed based on the updated ordered relevance list; and
sending the relevance-driven feed over the network to the user input.

2. The method of claim 1, wherein the plurality of inputs comprise a plurality of monitored securities, a plurality of monitored series, or a plurality of monitored metrics.

3. The method of claim 2, wherein the plurality of monitored series are a plurality of data series based on non-traded economic and financial data.

4. The method of claim 2, wherein the plurality of monitored metrics are a plurality of quantifiable measures used to track and assess a plurality of factors attributable to the monitored securities, the monitored series, or both.

5. The method of claim 2, wherein the plurality of inputs further comprise a plurality of component weightings within indices, a plurality of sector weightings, or a plurality of proprietary groupings.

6. The method of claim 1, wherein the unique combination of the inputs are evaluated over a time period compared to a historical data set for the unique combination of the inputs.

7. The method of claim 1, wherein each of the plurality of inputs are compared to a plurality of historical data to generate the plurality of relevance scores.

8. The method of claim 1, wherein the ordered relevance list is based on a time-based performance of the financial asset.

9. The method of claim 1, wherein the ordered relevance list is based on a trading volume of the financial asset.

10. The method of claim 1, wherein the ordered relevance list is based on a daily trading range of the monitored item

11. The method of claim 1, wherein the monitored item is a security.

12. The method of claim 1, wherein the monitored item is an equity index, a sector, or a proprietarily defined group.

13. The method of claim 1, wherein the feed is a macro feed, a performance feed, a breadth feed, a bearish feed, or a bullish feed.

14. The method of claim 1 further comprising the step of generating a second plurality of relevance scores for a second monitored item.

15. The method of claim 14 further comprising the step of evaluating and ranking a relevance of the monitored item against the second monitored item.

16. A system for generating a relevance-driven feed for financial market data comprising:
a server comprising a memory storing a set of software instructions, that when executed by a processor, causes the server to:
access a plurality of financial market data from a plurality of external market data sources via a network;
import a plurality of inputs from the plurality of economic data for a plurality of monitored items;
create a data layer from the plurality of inputs of financial market data and
generate a plurality of relevance scores from the plurality of inputs;
create and continuously update an ordered relevance list of the plurality of relevance scores for each of the plurality of monitored items; and
transmit the continuously updated ordered relevance lists to one or more user interfaces.

17. The system of claim 16, wherein the plurality of relevance scores are each based on a unique combination of the plurality of inputs.

18. The system of claim 16, wherein the ordered relevance list is based on a time-based performance of the plurality of monitored items, a trading volume of the plurality of monitored items, or a daily trading range of the plurality of monitored items and then compared to a plurality of historical data.

19. The system of claim 16, wherein the server is further configured to evaluate and rank each of the plurality of monitored items by each of the respective ordered relevance lists.

20. A system for generating a relevance-driven feed for financial market data for a plurality of users via a network, the relevance-driven feed including an ordered relevance list configured to allow a user to evaluate and rank related and unrelated securities and series based on a plurality of inputs of financial market data for each of the related and unrelated securities and series, the system comprising:
a first logic stored in a memory, that when executed by a processor causes the processor to access a plurality of monitored items data from a plurality of external data sources via the network;
a second logic stored in the memory, that when executed by a processor causes the processor to create a data layer from a plurality of inputs of financial market data and generate a plurality of relevance scores from the plurality of inputs;
a third logic stored in the memory, that when executed by a processor causes the processor to create and continuously update an ordered relevance list of the plurality of relevance scores for each of the plurality of financial assets; and
a fourth logic stored in the memory, that when executed by a processor causes the processor to transmit the continuously updated ordered relevance lists to one or more user interfaces via the network.
